(19) United States
(12) Patent Application Publication
(10) Pub. No.: US 2019/0305372 A1
(43) Pub. Date: Oct. 3, 2019

(54) LITHIUM SECONDARY BATTERY INCLUDING AN ELECTROLYTE ADDITIVE

(71) Applicants: Samsung Electronics Co., Ltd., Suwon-si (KR); Samsung SDI Co., Ltd., Yongin-si (KR)

(72) Inventors: Eunha PARK, Seoul (KR); Myongchun KOH, Hwaseong-si, Gyeonggi-do (KR); Insun PARK, Suwon-si, Gyeonggi-do (KR); Dongyoung KIM, Yongin-si, Gyeonggi-do (KR); Jihyun JANG, Yongin-si, Gyeonggi-do (KR); Yeonji CHUNG, Yongin-si, Gyeonggi-do (KR)

(21) Appl. No.: 16/136,417

(22) Filed: Sep. 20, 2018

(30) Foreign Application Priority Data
Mar. 28, 2018 (KR) 10-2018-0036014

(51) Int. Cl. H01M 10/0567; H01M 10/0525; H01M 4/525; H01M 10/0568; H01M 10/0569; H01M 4/505; H01M 4/587; H01M 4/36; H01M 4/38; H01M 10/42

(52) U.S. Cl. CPC H01M 10/0567; H01M 10/0525; H01M 4/525; H01M 10/0568; H01M 10/0569; H01M 2300/0025; H01M 4/587; H01M 4/364; H01M 4/386; H01M 10/4235; H01M 4/505

(57) ABSTRACT

A lithium secondary battery including: a positive electrode; a negative electrode; and an electrolyte between the positive electrode and the negative electrode,
wherein the positive electrode includes a positive active material represented by Formula 1,
the electrolyte includes a lithium salt; a non-aqueous solvent; and a difluorosilane compound represented by Formula 2, and
an amount of the difluorosilane compound is about 5 weight percent, based on a total weight of the electrolyte

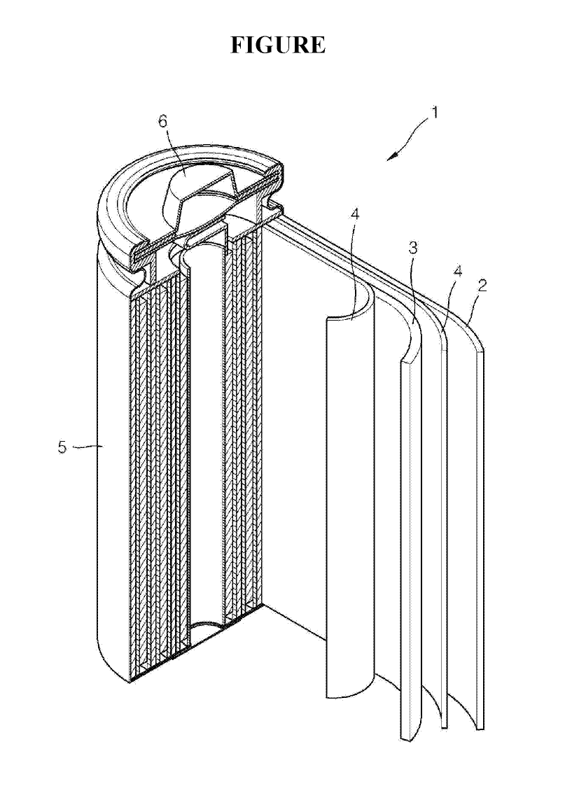

LiₓNi_{y}M_{1-y}O_{2-z}A_{z} Formula 1

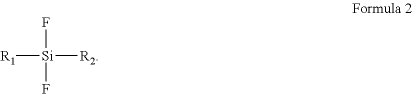

### CROSS-REFERENCE TO RELATED APPLICATION

This application claims priority to and the benefit of Korean Patent Application No. 10-2018-0036014, filed on Mar. 28, 2018, in the Korean Intellectual Property Office, and all the benefits accruing therefrom under 35 U.S.C. § 119, the content of which is incorporated herein in its entirety by reference.

### BACKGROUND

### 1. Field

The present disclosure relates to a lithium battery including an electrolyte additive.

### 2. Description of the Related Art

Lithium batteries may be used as power sources for portable electronic devices, such as video cameras, mobile phones, laptop computers, and the like. A rechargeable lithium battery, i.e., a lithium secondary battery, may have a specific energy that is three or more times greater than that of a lead storage battery, a nickel-cadmium battery, a nickel-hydrogen battery, a nickel-zinc battery, and the like, and may be rapidly charged. A lithium secondary battery may use a lithium-containing metal oxide as a positive active material included in a positive electrode. For example, a composite oxide of lithium and cobalt (Co), manganese (Mn), nickel (Ni), or a combination thereof may be used. Of these positive active materials, a high-nickel positive active material containing a high content of Ni is increasingly being studied for a higher-capacity battery. However, when a high-Ni positive active material is used, the positive electrode may have a weak surface structure, resulting in poor lifetime characteristics and high gas generation. Therefore, there is a need for a lithium secondary battery having high capacity and improved gas reduction characteristics.

### SUMMARY

Provided is a lithium secondary battery having a novel structure.

Additional aspects will be set forth in part in the description which follows and, in part, will be apparent from the description, or may be learned by practice of the presented embodiments.

According to an aspect of an embodiment, a lithium secondary battery includes: a positive electrode; negative electrode; and an electrolyte between the positive electrode and the negative electrode, wherein the positive electrode includes a positive active material represented by Formula 1, the electrolyte includes a lithium salt, a non-aqueous solvent, and a difluorosilane compound represented by Formula 2, and an amount of the difluorosilane compound is about 5 weight percent or less, based on a total weight of the electrolyte

LiₓNi_{y}M_{1-y}O_{2-z}A_{z} Formula 1

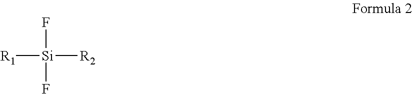

wherein, in Formula 1, 0.9≤x≤1.2, 0.7≤y≤0.95, and 0≤z≤0.2,
M is Al, Mg, Mn, Co, Fe, Cr, V, Ti, Cu, B, Ca, Zn, Zr, Nb, Mo, Sr, Sb, W, Bi, or a combination thereof, A is an element having an oxidation number −1, −2, or −3, and, in Formula 2, R₁ to R₂ are each independently a substituted or unsubstituted linear or branched C₁-C₃₀ alkyl group, a substituted or unsubstituted C₂-C₂₀ vinyl group, a substituted or unsubstituted C₂-C₂₀ allyl group, or a substituted or unsubstituted C₈-C₆₀ aryl group.

In an aspect, a lithium secondary battery includes: a positive electrode including a positive active material represented by the formula LiₓNi_{y}M_{1-y}O₂, wherein 0.9≤x≤1.2, 0.7≤y≤0.98, and M is Al, Mg, Mn, Co, Fe, Cr, V, Ti, Cu, B, Ca, Zn, Zr, Nb, Mo, Sr, Sb, W, Bi, or a combination thereof; a negative electrode; and an electrolyte between the positive electrode and the negative electrode, the electrolyte including a lithium salt, a non-aqueous solvent, and a difluorosilane compound, the difluorosilane compound including diethyl difluorosilane, dipropyl difluorosilane, ethyl phenyl difluorosilane, diphenyl difluorosilane, or a combination thereof, wherein an amount of the difluorosilane compound is in a range of about 0.1 weight percent to about 5 weight percent, based on a total weight of the electrolyte.

Also disclosed is a method of forming a lithium secondary battery, the method including: providing a positive electrode and a negative electrode; and disposing an electrolyte between the positive electrode and the negative electrode to form the lithium secondary battery, wherein the positive electrode includes a positive active material represented by Formula 1,

LiₓNi_{y}M_{1-y}O_{2-z}A_{z} Formula 1

wherein, in Formula 1, 0.9≤x≤1.2, 0.7≤y≤0.98, and 0≤z≤0.2, M is Al, Mg, Mn, Co, Fe, Cr, V, Ti, Cu, B, Ca, Zn, Zr, Nb, Mo, Sr, Sb, W, Bi, or a combination thereof, and A is an element having an oxidation number of −1, −2, or −3,
the electrolyte includes a lithium salt, a non-aqueous solvent, and a difluorosilane compound represented by Formula 2,

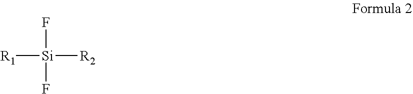

wherein, in Formula 2, R₁ to R₂ are each independently a substituted or unsubstituted linear or branched C₁-C₃₀ alkyl group, a substituted or unsubstituted C₂-C₂₀ vinyl group, a substituted or unsubstituted C₂-C₂₀ allyl group, or a substituted or unsubstituted C₆-C₆₀ aryl group, and an amount of the difluorosilane compound is about 5 weight percent or less, based on a total weight of the electrolyte.

### BRIEF DESCRIPTION OF THE DRAWING

These and/or other aspects will become apparent and more readily appreciated from the following description of the embodiments, taken in conjunction with the FIGURE, which is a schematic view of a lithium battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the FIGURES, to explain aspects. As used herein, the term “and/or” includes any and all combinations of one or more of the associated listed items.

It will be understood that when an element is referred to as being “on” another element, it can be directly on the other element or intervening elements may be present therebetween. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A C rate means a charge and discharge rate of a cell, and is obtained by dividing a total capacity of the cell by a total discharge period of time of 1 h, e.g., a C rate for a battery having a discharge capacity of 1.6 ampere-hours would be 1.6 amperes.

“Aliphatic” means a saturated or unsaturated linear or branched hydrocarbon group. An aliphatic group may be an alkyl, alkenyl, or alkynyl group, for example.

“Alkoxy” means an alkyl group that is linked via an oxygen (i.e., alkyl-O—), for example methoxy, ethoxy, and sec-butyloxy groups.

“Alkyl” means a straight or branched chain, saturated, monovalent hydrocarbon group (e.g., methyl or hexyl).

“Alkynyl” means a straight or branched chain, monovalent hydrocarbon group having at least one carbon-carbon triple bond (e.g., ethynyl).

“Allyl” refers to the unsaturated hydrocarbon group —CH═CHCH₂.

“Arene” means a hydrocarbon having an aromatic ring, and includes monocyclic and polycyclic hydrocarbons wherein the additional ring(s) of the polycyclic hydrocarbon may be aromatic or nonaromatic. Specific arenes include benzene, naphthalene, toluene, and xylene.

“Aryl” means a monovalent group formed by the removal of one hydrogen atom from one or more rings of an arene (e.g., phenyl or naphthyl).

“Arylalkyl” means a substituted or unsubstituted aryl group covalently linked to an alkyl group that is linked to a compound (e.g., a benzyl is a C7 arylalkyl group).

“Cycloalkenyl” means a monovalent group having one or more rings and one or more carbon-carbon double bond in the ring, wherein all ring members are carbon (e.g., cyclopentyl and cyclohexyl).

“Cycloalkyl” means a monovalent group having one or more saturated rings in which all ring members are carbon (e.g., cyclopentyl and cyclohexyl).

“Cycloalkynyl” means a stable aliphatic monocyclic or polycyclic group having at least one carbon-carbon triple bond, wherein all ring members are carbon (e.g., cyclohexynyl).

“Ester” refers to a group of the formula —O(C═O)R^{x} or a group of the formula —(C═O)OR^{x} wherein R^{x} is C1 to C28 aromatic organic group or aliphatic organic group. An ester group includes a C2 to C30 ester group, and specifically a C2 to C18 ester group.

The prefix “hetero” means that the compound or group includes at least one a heteroatom (e.g., 1, 2, or 3 heteroatom(s)), wherein the heteroatom(s) is each independently N, O, S, Si, or P.

“Heteroalkyl” is an alkyl group that comprises at least one heteroatom covalently bonded to one or more carbon atoms of the alkyl group. Each heteroatom is independently chosen from nitrogen (N), oxygen (O), sulfur (S), and or phosphorus (P).

“Heteroaryl” means a monovalent carbocyclic ring group that includes one or more aromatic rings, in which at least one ring member (e.g., one, two or three ring members) is a heteroatom. In a C3 to C30 heteroaryl, the total number of ring carbon atoms ranges from 3 to 30, with remaining ring atoms being heteroatoms. Multiple rings, if present, may be pendent, spiro or fused. The heteroatom(s) are generally independently nitrogen (N), oxygen (O), P (phosphorus), or sulfur (S).

“Heteroarylalkyl” means a heteroaryl group linked via an alkylene moiety. The specified number of carbon atoms (e.g., C3 to C30) means the total number of carbon atoms present in both the aryl and the alkylene moieties, with remaining ring atoms being heteroatoms.

“Substituted” means a compound or radical substituted with at least one (e.g., 1, 2, 3, 4, 5, 6 or more) substituent, and the substituents are independently a halogen (e.g., F⁻, Cl⁻, Br⁻, I⁻), a hydroxyl, an alkoxy, a nitro, a cyano, an amino, an azido, an amidino, a hydrazino, a hydrazono, a carbonyl, a carbamyl, a thiol, a C1 to C6 alkoxycarbonyl, an ester, a carboxyl, or a salt thereof, sulfonic acid or a salt thereof, phosphoric acid or a salt thereof, a C₁ to C₂₀ alkyl, a C₂ to C₁₆ alkynyl, a C₆ to C₂₀ aryl, a C₇ to C₁₃ arylalkyl, a C₁ to C₄ oxyalkyl, a C₁ to C₂₀ heteroalkyl, a C₃ to C₂₀ heteroaryl (i.e., a group that comprises at least one aromatic ring, wherein at least one ring member is other than carbon), a C₃ to C₂₀ heteroarylalkyl, a C₃ to C₂₀ cycloalkyl, a C₃ to C₁₅ cycloalkenyl, a C₆ to C₁₅ cycloalkynyl, a C₅ to C₁₅ heterocycloalkyl, or a combination including at least one of the foregoing, instead of hydrogen, provided that the substituted atom's normal valence is not exceeded.

“Vinyl” refers to the group —CH₂═CH₂).

Hereinafter, example embodiments of a lithium secondary battery will now be described in greater detail.

An aspect of the present disclosure provides a lithium secondary battery including: a positive electrode; a negative electrode; and an electrolyte between the positive electrode and the negative electrode, wherein

the positive electrode includes a positive active material represented by Formula 1,

the electrolyte includes a lithium salt, a non-aqueous solvent, and a difluorosilane-based compound represented by Formula 2, and

an amount of the difluorosilane-based compound is about 5 weight percent (wt %) or less, based on a total weight of the electrolyte,

LiₓNi_{y}M_{1-y}O_{2-z}A_{z} Formula 1

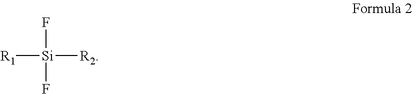

### In Formula 1,

0.9≤x≤1.2, 0.7≤y≤0.98, and 0≤z<0.2,

M is Al, Mg, Mn, Co, Fe, Cr, V, Ti, Cu, B, Ca, Zn, Zr, Nb, Mo, Sr, Sb, W, Bi, or a combination thereof, and

A is an element having an oxidation number of −1, −2, or −3, and in Formula 2,

R₁ to R₂ are each independently a substituted or unsubstituted linear or branched C₁-C₃₀ alkyl group, a substituted or unsubstituted C₂-C₂₀ vinyl group, a substituted or unsubstituted C₂-C₂₀ allyl group, or a substituted or unsubstituted C₆-C₆₀ aryl group.

A lithium metal composite oxide having a high nickel content may be desirable because it can provide high capacity. However, and while not wanting to be bound by theory, it is understood that the high Ni content may cause the release of Ni³⁺ cations from the positive electrode to the electrolyte, and Ni³⁺ cations may react with a solid electrolyte interphase (“SEI”) passivation film of the negative electrode so that the SEI passivation film is degraded. Then, the negative active material may be partially exposed to the electrolyte, and a side reaction may be caused thereafter, resulting in deterioration in capacity and lifetime characteristics, and an increase in gas generation. To address these drawbacks, the lithium secondary battery according to an embodiment may include the electrolyte containing a difluorosilane-based compound represented by Formula 2 to minimize a side reaction caused by Ni³⁺ cations, and to reduce gas generation.

While not wanting to be bound by theory, it is understood that the difluorosilane-based compound may have a high affinity to Ni³⁺ cations, and thus may inhibit a side reaction of Ni³⁺ cations, and may maintain a high affinity to Ni³⁺ cations even when a battery is operated at a high voltage, inhibiting the degradation of the SEI passivation film. In addition, the difluorosilane-based compound may be able to form a stable SEI passivation film including silicon (Si) on a surface of the negative electrode. Such a stable SEI passivation film formed on the surface of the negative electrode may then improve electrochemical characteristics of the battery by reducing gas generation caused by a side reaction. Consequently, and while not wanting to be bound by theory, it is understood that the difluorosilane-based compound may improve the stability of the SEI passivation film, and reduce gas generation in the lithium secondary battery, improving battery performance.

The amount of the difluorosilane-based compound in the electrolyte may be about 5 wt % or less, based on a total weight of the electrolyte. However, embodiments are not limited thereto. The difluorosilane-based compound may be added in any suitable amount that is sufficient to stabilize Ni³⁺ cations released from the positive active material to the electrolyte and allow formation of a protection film by using the difluorosilane-based compound on a surface of the negative electrode. When the amount of the difluorosilane-based compound exceeds 5 wt %, the difluorosilane-based compound itself may be decomposed, increasing film resistance and likely deteriorating battery capacity, storage stability, and cycle characteristics.

For example, the amount of the difluorosilane-based compound may be about 0.1 wt % or greater to about 5 wt % or less, based on a total weight of the electrolyte. In some embodiments, the amount of the difluorosilane-based compound may be about 0.1 wt % or greater to about 3 wt % or less, and in some other embodiments, about 0.2 wt % or greater to about 3 wt % or less, and in still other embodiments, about 0.5 wt % or greater to about 2 wt % or less, based on a total weight of the electrolyte.

When the amount of the difluorosilane-based compound is less than 0.1 wt %, the amount of the difluorosilane-based compound may be too small to form a suitable protective film and to obtain a sufficient resistance reduction effect.

In some embodiments, R₁ to R₂ may each independently be a substituted or unsubstituted linear or branched C₁-C₃₀ alkyl group, a substituted or unsubstituted C₂-C₂₀ vinyl group, a substituted or unsubstituted C₂-C₂₀ allyl group, or a substituted or unsubstituted C₆-C₆₀ aryl group.

For example, the C₁-C₃₀ alkyl group may be a methyl group, an ethyl group, a propyl group, an isopropyl group, a butyl group, a sec-butyl group, a tert-butyl group, and an iso-butyl group. However, embodiments are not limited thereto.

For example, the C₆-C₆₀ aryl group may be a phenyl group, a biphenyl group, and a ter-phenyl group. However, embodiments are not limited thereto.

In some embodiments, the difluorosilane-based compound may include diethyl difluorosilane, dipropyl difluorosilane, ethyl phenyl difluorosilane, diphenyl difluorosilane, or a combination thereof.

In some embodiments, the electrolyte may include a lithium salt. The lithium salt may serve as a source of lithium ions in the battery, dissolved in an organic solvent, for example, facilitating migration of lithium ions between the positive electrode and the negative electrode.

Anions of the lithium salt in the electrolyte may include PF₆⁻, BF₄⁻, SbF₆⁻, AsF₆⁻, C₄F₉SO₃⁻, ClO₄⁻, AlO₂⁻, AlCl₄⁻, CₓF₂ₓ₊₁SO₃⁻ (wherein x is a natural number), (CₓF₂ₓ₊₁SO₂)(C_{y}F_{2y+1}SO₂)N⁻ (wherein x and y are natural numbers), a halide, or a combination thereof.

For example, the lithium salt may include lithium difluoro(oxalato)borate (“LiDFOB”), LiBF₄, LiPF₆, LiCF₃SO₃, LiN(CF₃SO₂)₂, LiN(FSO₂)₂, or a combination thereof. For example, the lithium salt may be LiDFOB or LiPF₆:

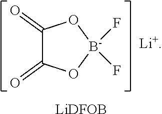

In some embodiments, the lithium salt may include LiDFOB and LiPF₆, wherein an amount of LiDFOB may be about 2 wt % or less, based on a total weight of the electrolyte.

For example, the lithium salt may include LiN(FSO₂)₂ or LiPF₆. In some embodiments, the lithium salt may include LiN(FSO₂)₂ and LiPF₆, wherein an amount of LiN(FSO₂)₂ may be about 10 wt % or less, based on a total weight of the electrolyte.

An amount of the lithium salt in an electrolyte not containing a solvent may be in a range of about 0.001 wt % to about 30 wt %, based on a total weight of the electrolyte not containing a solvent. However, embodiments are not limited thereto. The lithium salt may be added in any suitable amount that is sufficient to efficiently transfer lithium ions and/or electrons during charge/discharge cycles.

An amount of the lithium salt in an electrolyte containing a solvent may be in a range of about 100 millimoles per liter (mM) to about 10 moles per liter (M), and in some other embodiments, about 100 mM to about 2 M, and in still other embodiments, about 500 mM to about 2 M. However, the amount is not particularly limited thereto. The lithium salt may be added in any suitable amount that is sufficient to efficiently transfer lithium ions and/or electrons during charge/discharge cycles.

For example, the non-aqueous solvent may include a carbonate-based solvent, an ester-based solvent, an ether-based solvent, a ketone-based solvent, an aprotic solvent, or a combination thereof. Non-limiting examples of the carbonate-based solvent may be dimethyl carbonate (“DMC”), diethyl carbonate (“DEC”), ethyl methyl carbonate (“EMC”), dipropyl carbonate (“DPC”), methylpropyl carbonate (“MPC”), ethylpropyl carbonate (“EPC”), ethylene carbonate (“EC”), propylene carbonate (“PC”), butylene carbonate (“BC”), or tetraethylene glycol dimethyl ether (“TEGDME”). Non-limiting examples of the ester-based solvent may be methyl acetate, ethyl acetate, n-propyl acetate, dimethyl acetate, methyl propionate, ethyl propionate, γ-butyrolactone, decanolide, valerolactone, mevalonolactone, and caprolactone. Non-limiting examples of the ether-based solvent may be dibutyl ether, tetraglyme, diglyme, dimethoxy ethane, 2-methyltetrahydrofuran, and tetrahydrofuran. An example of the ketone-based solvent may be cyclohexanone.

The aprotic solvent may be used alone or in combination with at least one other solvent. For example, a mixing ratio of solvents may be appropriately controlled according to desired performance of a battery.

In some embodiments, the carbonate-based solvent may be a mixed solvent of a linear solvent and a cyclic carbonate. When a mixed ratio of the linear carbonate to the cyclic carbonate is about 1:1 to about 9:1 by volume, the electrolyte may have improved performance.

In some other embodiments, the non-aqueous solvent may further include fluoroethylene carbonate (“FEC”), vinylene carbonate (“VC”), vinyl ethylene carbonate (“VEC”), a phosphorus (P)-containing compound, a sulfur (S)-containing compound, or the like.

In some embodiments, the non-aqueous solvent may include fluoroethylene carbonate (“FEC”). For example, the lithium secondary battery may include FEC in an amount of about 0.1 volume percent (vol %) to about 10 vol %, based on a total volume of the non-aqueous solvent. In some embodiments, the lithium secondary battery may include FEC in an amount of about 0.5 vol % to about 7 vol %, and in some other embodiments, about 1 vol % to about 7 vol %, and in some other embodiments, about 2 vol % to about 7 vol %, each, based on a total volume of the non-aqueous solvent. When the amount of the FEC in the non-aqueous solvent is within these ranges, an effective SEI passivation film which does not inhibit diffusion rate of lithium ions may be rapidly formed.

The electrolyte may include a carbonate including a carbon-carbon single or multiple bonds, a carboxylic anhydride including a carbon-carbon double bond or multiple bonds, or a combination thereof. The multiple bonds may include a double bond or a triple bond. The carbonate and the carboxylic anhydride may be linear or cyclic.

For example, the electrolyte may further include VC, VEC, a maleic anhydride, a succinic anhydride, or a combination thereof. For example, the electrolyte may further include VC.

For example, the electrolyte may further include VC, VEC, a maleic anhydride, a succinic anhydride, or a combination thereof. For example, the lithium secondary battery may further include VC, VEC, a maleic anhydride, a succinic anhydride, or a combination thereof in an amount of about 0.1 wt % to about 2 wt %, and in some embodiments, about 0.1 wt % to about 1.5 wt %, based on a total weight of the electrolyte.

For example, the electrolyte may further include a maleic anhydride. However, embodiments are not limited thereto. For example, the lithium secondary battery may further include a maleic anhydride in an amount of about 0.1 wt % to about 1.5 wt %, and in some embodiments, about 0.1 wt % to about 1.0 wt %, and in some other embodiments, about 0.1 wt % to about 0.5 wt %, about 0.2 wt % to about 0.4 wt %, or about 0.3 wt %, based on a total weight of the electrolyte.

In an embodiment, the electrolyte includes vinylene carbonate, maleic anhydride, or a combination thereof in an amount of about 0.1 weight percent to about 2 weight percent, about 0.2 weight percent to about 1.5 weight percent, or about 0.4 weight percent to about 1 weight percent, based on a total weight of the electrolyte

For example, the electrolyte may further include a phosphorous (P)-containing compound, a sulfur (S)-containing compound, or a combination thereof. For example, the electrolyte may further include a phosphorous (P)-containing compound, a sulfur (S)-containing compound, or a combination thereof in an amount of about 2 wt % or less, in some embodiments, about 0.1 wt % or greater to about 2 wt % or less, and in some other embodiments, about 0.1 wt % or greater to about 1.5 wt % or less, and in still other embodiments, about 0.1 wt % or greater to about 1 wt % or less, each based on a total weight of the electrolyte.

The P-containing compound may be a phosphine compound, a phosphite compound, or a combination thereof. The S-containing compound may be a sulfone compound, a sulfonate compound, a disulfonate compound, or a combination thereof.

For example, the phosphine compound may be triphenylphosphine, tris(4-fluorophenyl)phosphine, tris(2,4-difluorophenyl)phosphine, or tris(perfluorophenyl)phosphine. However, embodiments are not limited thereto. For example, the phosphite compound may be triethylphosphite (“TEPi”), trimethylphosphite, tripropylphosphite, tributylphosphite, tris (trimethylsilyl) phosphite, or triphenylphosphite. However, embodiments are not limited thereto.

The sulfone compound may be, for example, ethylmethyl sulfone, divinyl sulfone, or tetramethylene sulfone. However, embodiments are not limited thereto. For example, the sulfonate compound may be methyl methane sulfonate, ethyl methane sulfonate, or diallyl sulfonate. However, embodiments are not limited thereto. The disulfonate compound may be, for example, methylene methane disulfonate (“MMDS”) or busulfan. However, embodiments are not limited thereto.

As described above, in spite of its ability to provide a high-capacity battery, a lithium metal oxide having a high Ni content may lead to poor lifetime characteristics and an increased resistance in a battery due to for example an increased amount of Ni³⁺ cations. As described above, when the disulfonate compound is included, the sulfonate moiety of the disulfonate compound may stabilize Ni³⁺ cations by reaction with the same, and resistance may be reduced. In this regard, when the amount of the disulfonate compound is greater than 2 wt %, based on a total weight of the electrolyte, the disulfonate moiety of the disulfonate compound may react with lithium cations generated from the positive active material, and prevent the lithium cations from further contributing to battery capacity.

The difluorosilane-based compound represented by Formula 2 may decompose when in direct contact with the negative electrode. As is further described below, in a lithium secondary battery containing a negative active material including a metal or metalloid alloyable with lithium or a carbonaceous negative active material, gas may be generated by a catalytic reaction and lifetime characteristics may be deteriorated. The gas generation is understood to be exacerbated at high temperature. As described above, when FEC, VC, VEC, a phosphorous (P)-containing compound, or a sulfur (S)-containing compound is included in the above-described ranges, a passivation layer, i.e., a SEI passivation film, may be locally or entirely formed on a surface of the negative electrode. The SEI passivation film may prevent generation of gas during storage at a high temperature, and safety and performance of the lithium secondary battery may be improved.

Hereafter, the structure of the lithium secondary battery will be described in detail.

The positive electrode may include the positive active material represented by Formula 1, and for example, in Formula 1, A may be a halogen, S, or N. However, embodiments are not limited thereto.

For example, in Formula 1, y, which indicates an amount of Ni in the positive active material, may satisfy that 0.7≤y≤0.98, and in some embodiments, 0.8≤y≤0.98, and in some other embodiments, 0.8≤y≤0.9, and in still other embodiments, 0.8≤y≤0.88. When the amount of Ni in the positive active material is less than 70%, though the amount of Ni may be small enough that the surface of the positive electrode is sufficiently stable and inhibit deterioration in lifetime characteristics such as the release of Ni³⁺ cations or disproportionation which occurs when using a high-Ni positive active material, resistance may rather be increased since a phosphate, which has a high affinity to Ni³⁺ cations is located on a surface of the positive electrode, and lifetime characteristics and resistance characteristics may be degraded.

For example, the positive active material may be represented by Formula 3 or Formula 4:

LiNi_{y′}Co_{1-y′-z′}Al_{z∝0}O₂ Formula 3

LiNi_{y″}Co_{1-y″-z″}Mn_{z″}O₂ Formula 4

In Formula 3, 0.9≤x′≤1.2, 0.8≤y′≤0.98, 0<z′<0.1, and 0<1-y′-z′<0.2, and in Formula 4, 0.9≤x″≤1.2, 0.8≤y″≤0.98, 0<z″<0.1, and 0<1-y″-z″<0.2.

For example, the positive electrode may include, as a positive active material, Li_{1.02}Ni_{0.80}Co_{0.15}Mn_{0.05}O₂, Li_{1.02}Ni_{0.85}Co_{0.1}Mn_{0.05}O₂, Li_{1.02}Ni_{0.88}Co_{0.08}Mn_{0.04}O₂, Li_{1.02}Ni_{0.80}Co_{0.15}Al_{0.05}O₂, Li_{1.02}Ni_{0.85}Co_{0.1}Al_{0.05}O₂, Li_{1.02}Ni_{0.88}Co_{0.08}Al_{0.04}O₂, LiNi_{0.80}Co_{0.15}Mn_{0.05}O₂, LiNi_{0.85}Co_{0.1}Mn_{0.05}O₂, LiNi_{0.88}Co_{0.08}Mn_{0.04}O₂, LiNi_{0.80}Co_{0.15}Al_{0.05}O₂, LiNi_{0.85}Co_{0.1}Al_{0.05}O₂, LiNi_{0.88}Co_{0.08}Al_{0.04}O₂, or a combination thereof. For example, the positive electrode may include, as a positive active material, LiNi_{0.88}Co_{0.08}Al_{0.04}O₂, LiNi_{0.88}Co_{0.08}Mn_{0.04}O₂, Li_{1.02}Ni_{0.88}Co_{0.08}Al_{0.04}O₂, Li_{1.02}Ni_{0.88}Co_{0.08}Mn_{0.04}O₂, or a combination thereof. However, embodiments are not limited thereto.

The positive electrode may further include, in addition to such a positive active material as described above, lithium cobalt oxide, lithium nickel cobalt manganese oxide, lithium nickel cobalt aluminum oxide, lithium iron phosphate, lithium manganese oxide, or a combination thereof. However, embodiments are not limited thereto. The positive electrode may further include any suitable positive active material.

For example, the positive electrode may further include a compound represented by a formulae of: LiₐA_{1-b}B′_{b}D₂ (wherein 0.90≤a≤1.8, and 0≤b≤0.5); LiₐE_{1-b}B′_{b}O_{2-c}D_{c} (wherein 0.90≤a≤1.8, 0≤b≤0.5, and 0≤c≤0.05); LiE_{2-b}B′_{b}O_{4-c}D_{c} (wherein 0≤b≤0.5, and 0≤c≤0.05); LiₐNi_{1-b-c}Co_{b}B′_{c}D_{α} (wherein 0.90≤a≤1.8, 0≤c≤0.05, and 0<α≤2); LiₐNi_{1-b-c}Co_{b}B′_{c}O_{2-α}F′_{α} (wherein 0.90≤a≤1.8, 0≤b≤0.5, 0≤c≤0.05, and 0<α≤2); LiₐNi_{1-b-c}Co_{b}B′_{c}O_{2-α}F′_{α} (wherein 0.90≤a≤1.8, 0≤b≤0.5, 0≤c≤0.05, and 0<α<2); LiₐNi_{1-b-c}Mn_{b}B′_{c}D_{α} (wherein 0.90≤a≤1.8, 0≤b≤0.5, 0≤c≤0.05, and 0<α≤2); LiₐNi_{1-b-c}Mn_{b}B′_{c}O_{2-α}F′_{α} (wherein 0.90≤a≤1.8, 0≤b≤0.5, 0≤c≤0.05, and 0<α≤2); LiₐNi_{1-b-c}Mn_{b}B′_{c}O_{2-α}F′_{α} (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.5, 0≤d≤0.5, and 0.001≤d≤0.1); LiₐNi_{b}Co_{c}Mn_{d}GₑO₂ (wherein 0.90≤a≤1.8, 0≤b≤0.5, 0≤c≤0.5, 0≤d≤0.5, and 0.001≤e≤0.1); LiₐNiG_{b}O₂ (wherein 0.90≤a≤1.8, and 0.0010.1); LiₐCoG_{b}O₂ (wherein 0.90≤a≤1.8, and 0.0010.1); LiₐMnG_{b}O₂ (wherein 0.90≤a≤1.8, and 0.001≤b≤0.1); LiₐMn₂G_{b}O₄ (wherein 0.90≤a≤1.8, and 0.001≤b≤0.1); QO₂; QS₂; LiQS₂; V₂O₅; LiV₂O₅; LiI′O₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄.

In the formulae above, A may be Ni, Co, Mn, or a combination thereof; B′ may be Al, Ni, Co, Mn, Cr, Fe, Mg, Sr, V, a rare earth element, or a combination thereof; D may be O, F, S, P, or a combination thereof; E may be Co, Mn, or a combination thereof; F′ may be F, S, P, or a combination thereof; G may be Al, Cr, Mn, Fe, Mg, La, Ce, Sr, V, or a combination thereof; Q may be Ti, Mo, Mn, or a combination thereof; I′ may be Cr, V, Fe, Sc, Y, or a combination thereof; and J may be V, Cr, Mn, Co, Ni, Cu, or a combination thereof.

For example, the positive electrode of the lithium secondary battery according to embodiments may be prepared according to the following method.

The positive electrode may be formed by coating, drying, and then pressing a positive active material onto a positive electrode current collector. A positive active material composition may be prepared as a mixture of such a positive active material as described above, a binder, and a solvent as desired.

For example, a conducting agent, a filler, or the like may be further added to the positive active material composition.

The positive active material composition may be directly coated on the positive electrode current collector and then dried to form a positive electrode. In some other embodiments, the positive active material composition may be cast on a separate support to form a positive active material film. This positive active material film may then be separated from the support and then laminated on the positive electrode current collector, to thereby form the positive electrode.

For example, a loading level of the prepared positive active material composition may be about 30 milligrams per square centimeter (mg/cm²) or greater, and in some embodiments, about 35 mg/cm² or greater, and in some other embodiments, about 40 mg/cm² or greater. For example, the positive electrode may have an electrode density of about 3 grams per cubic centimeter (g/cc) or greater, and in some embodiments, about 3.5 g/cc or greater.

In some embodiments, to obtain an increased cell energy density, the loading level of the positive active material composition may be about 35 mg/cm² or greater to about 50 mg/cm² or less, and the electrode density of the positive electrode may be about 3.5 g/cc or greater to about 4.2 g/cc or less.

In some embodiments, the positive active material composition may be loaded onto opposite surfaces of the positive electrode current collector to a loading level of about 37 mg/cm² to achieve an electrode density of about 3.6 g/cc.

When the loading level of the positive active material composition and the electrode density are within the above-described ranges, a lithium secondary battery including the positive active material may have an increased cell energy density of, for example, about 500 watt-hours per liter (Wh/L) or greater to about 900 Wh/L or less.

The solvent may be, for example, N-methylpyrrolidone (“NMP”), acetone, or water. The amount of the solvent may be about 10 parts to about 100 parts by weight, based on 100 parts by weight of the positive active material. When the amount of the solvent is within this range, forming the positive active material film may be facilitated.

The conducting agent may be added in an amount of about 1 wt % to about 30 wt %, based on a total weight of positive active material composition including the positive active material. The conducting agent may be any suitable conductive material. Non-limiting examples of the conducting agent may include graphite, such as natural graphite or artificial graphite; carbon black, acetylene black, Ketjen black, channel black, furnace black, lamp black, or summer black; conductive fibers, such as carbon fibers or metal fibers; carbon fluoride; a metal powder, such as aluminum or nickel powder; conductive whiskers, such as zinc oxide or potassium titanate; a conductive metal oxide, such as a titanium oxide; and a conductive material, such as a polyphenylene derivative.

The binder may facilitate binding between the positive active material and the conducting agent, and binding to the current collector. For example, the amount of the binder may be about 1 wt % to about 30 wt %, based on a total weight of the positive active material composition. Non-limiting examples of the binder are polyvinylidene fluoride (“PVdF”), polyvinylidene chloride, polybenzimidazole, polyimide, polyvinyl acetate, polyacrylonitrile, polyvinyl alcohol, carboxymethyl cellulose (“CMC”), starch, hydroxypropyl cellulose, regenerated cellulose, polyvinylpyrrolidone, polyethylene, polypropylene, polystyrene, polymethyl methacrylate, polyaniline, acrylonitrile butadiene styrene copolymer, phenol resin, epoxy resin, polyethylene terephthalate, polytetrafluoroethylene, polyphenylene sulfide, polyamide imide, polyether imide, polyethylene sulfone, polyamide, polyacetal, polyphenylene oxide, polybutylene terephthalate, an ethylene-propylene-diene monomer (“EPDM”), sulfonated EPDM, styrene-butadiene rubber (“SBR”), fluoro rubber, and various copolymers. The filler may inhibit expansion of the positive electrode. The filler may be optional. The filler may be any suitable fibrous materials not causing a chemical change in the lithium secondary battery. However, embodiments are not limited thereto. For example, the filler may be an olefin-based polymer such as polyethylene or polypropylene; or a fibrous material such as glass fiber, carbon fiber, or the like.

The amounts of the positive active material, the conducting agent, the filler, the binder, and the solvent may be the same as amounts used in other lithium secondary batteries. At least one of the conducting agent, the filler, the binder, and the solvent may be omitted depending on the use and structure of the lithium secondary battery.

For example, N-methylpyrrolidone (“NMP”) may be used as the solvent, PVdF or a PVdF copolymer may be used as the binder, and carbon black or acetylene black may be used as the conducting agent. For example, after about 94 wt % of the positive active material, about 3 wt % of the binder, and about 3 wt % of the conducting agent are mixed together to obtain a mixture in power form, NMP may be added to the mixture to prepare a slurry having a solid content of about 70 wt %. This slurry may then be coated, dried, and roll-pressed, to thereby manufacture a positive electrode plate.

The positive electrode current collector may have a thickness of about 3 micrometers (μm) to about 50 μm. The positive electrode current collector is not particularly limited, and may be any suitable material having a high conductivity without causing chemical changes in the fabricated battery. For example, the positive electrode current collector may be stainless steel, aluminum, nickel, titanium, sintered carbon, or aluminum or stainless steel that is surface-treated with carbon, nickel, titanium, or silver. For example, the positive electrode current collector may be processed to have an uneven surface with fine projections and recesses to enhance the adhesion of the positive active material to the surface of the positive electrode current collector. The positive electrode current collector may be in any of various suitable forms, including a film, a sheet, a foil, a net, a porous structure, a foam, or a non-woven fabric.

For example, the negative electrode of the lithium secondary battery according to embodiments may include a negative active material containing a metal or metalloid that is alloyable with lithium, and/or a carbonaceous negative active material.

For example, the negative active material containing a metalloid that is alloyable with lithium may include silicon (Si), a Si—C composite material including Si particles, a silicon oxide (SiO_{a′}, wherein 0<a′<2), or a combination thereof.

For example, the Si particles in the Si—C composite material may have an average particle diameter of about 200 nanometers (nm) or less.

For example, the Si—C composite material may have a capacity of about 300 milliampere hours per gram (mAh/g) to about 700 mAh/g, and in some embodiments, about 400 mAh/g to about 600 mAh/g.

In addition to the above-described negative active materials, the negative electrode may further include Sn, Al, Ge, Pb, Bi, Sb, an Si—Y′ alloy (wherein Y′ may be an alkaline metal, an alkaline earth metal, a Group 13 to 16 element, a transition metal, a rare earth element, or a combination thereof, but may be not Si), an Sn—Y′ alloy (wherein Y′ may be an alkaline metal, an alkaline earth metal, a Group 13 element, a Group 14 element, a transition metal, a rare earth element, or a combination thereof, but may be not Sn). The element Y′ may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), thallium (TI), germanium (Ge), phosphorus (P), arsenic (As), antimony (Sb), bismuth (Bi), sulfur (S), selenium (Se), tellurium (Te), polonium (Po), or a combination thereof.

For example, the negative electrode of the lithium secondary battery according to embodiments may be prepared according to the following method.

The negative electrode may be formed by coating, drying, and the pressing a positive active material onto a negative electrode current collector. A negative active material composition may be prepared as a mixture of such a negative active material as described above, a binder, and a solvent as desired.

For example, a conducting agent, a filler, or the like may be further added to the negative active material composition.

The binder, the solvent, conducting agent, and the filler used in the negative active material composition may be the same as those used in the positive active material composition.

The negative active material composition may use water as a solvent, unlike the positive active material composition. For example, the negative active material composition may include water as a solvent; carboxymethyl cellulose (“CMC”), styrene-butadiene rubber (“SBR”), an acrylate polymer, or a methacrylate polymer as a binder; and carbon black, acetylene black, or graphite as a conducting agent. For example, after about 94 wt % of a negative active material, about 3 wt % of the binder, and about 3 wt % of the conducting agent are mixed together to obtain a mixture in powder form, water may be added to the mixture to prepare a slurry having a solid content of about 70 wt %. This slurry may then be coated, dried, and roll-pressed, to thereby manufacture a negative electrode.

A loading level of the negative active material composition may be determined according to the loading level of the positive active material composition.

For example, a loading level of the negative active material composition may be about 12 mg/cm² or greater, and in some example embodiments, about 15 mg/cm² or greater, depending on the capacity per gram of the negative active material composition. For example, the negative electrode may have an electrode density of about 1.5 g/cc or greater, and in some example embodiments, about 1.6 g/cc or greater.

In some embodiments, for an energy density-oriented design, a loading level of the negative active material composition may be about 15 mg/cm² or greater to about 25 mg/cm² or less, and an electrode density of the negative electrode may be about 1.6 g/cc or greater to about 2.3 g/cc or less.

When a loading level of the negative active material and a negative electrode density are within the above ranges, a lithium secondary battery including such a negative active material may exhibit a high cell energy density of about 500 Wh/L or greater.

The negative electrode current collector may have a thickness of about 3 μm to about 50 μm. The negative electrode current collector is not particularly limited, and may be any suitable material having suitable conductivity, not causing chemical changes in the fabricated battery. For example, the negative electrode current collector may be copper; stainless steel; aluminum; nickel; titanium; sintered carbon; copper or stainless steel that is surface-treated with carbon, nickel, titanium, or silver; or an aluminum-cadmium alloy. Similar to the positive electrode current collector, the negative electrode current collector may be processed to have an uneven surface with fine projections and recesses to enhance the adhesion of the negative active material to the surface of the negative electrode current collector. The negative electrode current collector may be in any of various suitable forms, including a film, a sheet, a foil, a net, a porous structure, a foam, or a non-woven fabric.

In some embodiments, the lithium secondary battery may exhibit a capacity retention rate of about 80% or greater after 200 charge/discharge cycles at a temperature of about 25° C. under a charge/discharge current of 1 C/1 C, an operating voltage in a range of about 2.8 volts (V) to about 4.3 V, and a cut-off current of 1/10 C in a constant current-constant voltage (“CC-CV”) mode.

The lithium secondary battery according to embodiments may have an excellent capacity retention rate and improved battery characteristics, compared to a high-Ni lithium secondary battery.

For example, an operating voltage of the lithium secondary battery may be from about 2.8 V to about 4.3 V.

For example, the lithium secondary battery may have an energy density of about 500 Wh/L or greater.

In some embodiments, the lithium secondary battery according to one or more embodiments may further include a separator between the positive electrode and the negative electrode. The separator may be an insulating thin film having a high ion permeability and strong mechanical intensity. The separator may have a pore diameter of about 0.001 μm to about 1 μm, and a thickness of about 3 μm to about 30 μm. The separator may be, for example, an olefin-based polymer such as polypropylene or the like having resistance to chemicals and hydrophobic characteristics; or a sheet or non-woven fabric made of glass fiber, polyethylene, or the like. When a solid electrolyte, for example, a polymer electrolyte is used, the solid electrolyte may also serve as the separator.

In some example embodiments, in addition to the above-described electrolytes, the electrolyte may further include a solid electrolyte, an organic solid electrolyte, or an inorganic solid electrolyte.

The organic solid electrolyte may be, for example, a polyethylene derivative, a polyethylene oxide derivative, a polypropylene oxide derivative, a phosphoric acid ester polymer, polyester sulfide, polyvinyl alcohol, polyfluoride vinylidene, or a polymer including ionic dissociative groups.

The inorganic solid electrolyte may be a lithium nitride, a lithium halide, or a lithium sulfate, for example, Li₃N, LiI, Li₅NI₂, Li₃N—LiI—LiOH, Li₂SiS₃, Li₄SiO₄, Li₄SiO₄—LiI—LiOH, or Li₃PO₄—Li₂S—SiS₂.

Referring to the FIGURE, a lithium secondary battery 1 includes a positive electrode 3, a negative electrode 2, and a separator 4. The above-described positive electrode 3, the negative electrode 2, and the separator 4 may be wound or folded to be housed in a battery case 5. Subsequently, an electrolyte may be injected into the battery case 5, and the battery case 5 may then be sealed with a cap assembly 6, to thereby complete the manufacture of the lithium secondary battery 1. The battery case 5 may be a cylindrical type, a rectangular type, or a thin-film type. For example, the lithium secondary battery 1 may be a large-sized thin-film type. The lithium secondary battery 1 may be a lithium ion battery.

The lithium secondary battery according to one or more embodiments may be manufactured using a method such as by injecting an electrolyte solution between the positive electrode and the negative electrode.

The above-described positive electrode, negative electrode, and separator may be wound or folded, and then housed in a battery case. Subsequently, an electrolyte may be injected into the battery case, and the battery case may then be sealed with a cap assembly, to thereby complete the manufacture of a lithium secondary battery. For example, the battery case may be a cylindrical type, a rectangular type, or a thin-film type.

The lithium secondary battery according to one or more embodiments may be a winding or a stack type according to a shape of the electrodes. The lithium secondary battery according to one or more embodiments may be classified into, e.g., as, a cylindrical type, a rectangular type, a coin type, or a pouch type according to the type of exterior material.

A detailed description of a method of manufacturing the lithium secondary battery according to one or more embodiments will be omitted.

An aspect of the present disclosure provides a battery module in which a plurality of lithium secondary batteries according to one or more embodiments may be used as unit cells.

In some embodiments, the battery module may be included in a battery pack.

An aspect of the present disclosure provides a device including the battery pack. For example, this device may be used in, for example, power tools actuated by electric motors; electric vehicles (“EVs”), including hybrid electric vehicles (“HEVs”), plug-in hybrid electric vehicles (“PHEV”), and the like; electric two-wheeled vehicles, including electric bicycles and electric scooters; electric golf carts; or power storage systems. However, embodiments are not limited thereto.

The lithium secondary battery according to one or more embodiments may be used for various purposes under high-power, high-voltage, and high-temperature operation conditions.

One or more embodiments of the present disclosure will now be described in detail with reference to the following examples. However, these examples are only for illustrative purposes and are not intended to limit the scope of the one or more embodiments of the present disclosure.

### Example 1

### Manufacture of Positive Electrode

LiNi_{0.88}Co_{0.08}Mn_{0.04}O₂ as a positive active material, carbon black as a conducting agent, and PVdF as a binder were added in a weight ratio of about 94:3:2 to N-methylpyrrolidone (“NMP”) and mixed together, and the mixture was dispersed at a loading level of 37 milligrams per square centimeter (mg/cm²) per surface to coat both surfaces of an aluminum foil having a thickness of 16 micrometers (μm), dried, and then roll-pressed to prepare a positive electrode having an electrode density of 3.6 grams per cubic centimeter (g/cc).

### Manufacture of Negative Electrode

SCN2 (an active material designed to exhibit a capacity of 1,300 milliampere hours per gram (mAh/g) by carbon-coating after preparing secondary particles including Si particles having a size of about 100 nanometers (nm)), graphite, CMC, and SBR were mixed and dispersed at a weight ratio of 13:85:1.5:0.5 in NMP. Both surfaces of a copper foil having a thickness of 15 μm were coated at a loading level of 17.25 mg/cm² per surface, dried, and then roll-pressed to prepare a negative electrode having an electrode density of 1.65 g/cc.

### Manufacture of Electrolyte

An electrolyte was prepared by adding about 1.5 weight percent (wt %) of VC and about 1 wt % of diethyl difluorosilane, based on a total weight of the electrolyte, to a mixture of FEC/EC/EMC/DMC (in a volume ratio of about 5:20:35:40) including 1.15 moles per liter (M) LiPF₆.

### Manufacture of Lithium Secondary Battery

A lithium secondary battery was manufactured by injecting the electrolyte between the positive electrode and the negative electrode with a polypropylene separator having a thickness of about 16 μm disposed between the positive and negative electrodes.

### Example 2

A lithium secondary battery was manufactured in the same manner as in Example 1, except that about 1 wt % of diphenyl difluorosilane was added, instead of about 1 wt % of diethyl difluorosilane, to prepare the electrolyte.

### Example 3

A lithium secondary battery was manufactured in the same manner as in Example 1, except that about 0.5 wt % of diethyl difluorosilane was added, instead of about 1 wt % of diethyl difluorosilane, to prepare the electrolyte.

### Example 4

A lithium secondary battery was manufactured in the same manner as in Example 1, except that about 2 wt % of diethyl difluorosilane was added, instead of about 1 wt % of diethyl difluorosilane, to prepare the electrolyte.

### Example 5

### Manufacture of Positive Electrode

LiNi_{0.88}Co_{0.08}Mn_{0.04}O₂ as a positive active material, carbon black as a conducting agent, and PVdF as a binder were added in a weight ratio of about 94:3:2 to NMP and mixed together, and the mixture was dispersed at a loading level of 37 mg/cm² per surface to coat both surfaces of an aluminum foil having a thickness of 16 μm, dried, and then roll-pressed to prepare a positive electrode having an electrode density of 3.6 g/cc.

### Manufacture of Negative Electrode

Graphite, CMC, and SBR were mixed and dispersed at a weight ratio of 98:1.5:0.5 in water, and the mixture was dispersed at a loading level of 21.86 mg/cm² per surface to coat both surfaces of a copper foil having a thickness of 10 μm, dried, and then roll-pressed to prepare a positive electrode having an electrode density of 1.65 g/cc.

### Preparation of Electrolyte

An electrolyte was prepared by adding about 1.5 wt % of VC and about 1 wt % of diethyl difluorosilane, based on a total weight of the electrolyte, to a mixture of FEC/EC/EMC/DMC (in a volume ratio of about 5:20:35:40) including 1.15 M LiPF₆.

### Manufacture of Lithium Secondary Battery

A lithium secondary battery was manufactured by injecting the electrolyte between the positive electrode and the negative electrode with a polypropylene separator having a thickness of about 16 μm disposed between the positive and negative electrodes.

### Example 6

A lithium secondary battery was manufactured in the same manner as in Example 5, except that about 1 wt % of diphenyl difluorosilane was added, instead of about 1 wt % diethyl difluorosilane, to prepare the electrolyte.

### Example 7

### Manufacture of Positive Electrode

LiNi_{0.88}Co_{0.08}Mn_{0.04}O₂ as a positive active material, carbon black as a conducting agent, and PVdF as a binder were added in a weight ratio of about 94:3:2 to NMP and mixed together, and the mixture was dispersed at a loading level of 37 mg/cm² per surface to coat both surfaces of an aluminum foil having a thickness of 16 μm, dried, and then roll-pressed to prepare a positive electrode having an electrode density of 3.6 g/cc.

### Manufacture of Negative Electrode

A negative active material, SSC-G (SSC (as an active material designed to exhibit a capacity of 1300 mAh/g by carbon-coating with chemical vapor deposition (CVD) and pitch after preparing secondary particles including Si particles having a size of about 100 nm) and graphite were mixed at a weight ratio of 14.7:85:3), and a binder, AG binder, were mixed and dispersed at a weight ratio of 96:4 in NMP. Both surfaces of a copper foil having a thickness of 8 μm were coated at a loading level of 17.6 mg/cm² per surface, dried, and then roll-pressed to prepare a negative electrode having an electrode density of 1.65 g/cc.

### Preparation of Electrolyte

An electrolyte was prepared by adding about 1.5 wt % of VC and about 1 wt % of diethyl difluorosilane, based on a total weight of the electrolyte, to a mixture of FEC/EC/EMC/DMC (in a volume ratio of about 5:20:35:40) including 1.15M LiPF₆.

### Manufacture of Lithium Secondary Battery

A lithium secondary battery was manufactured by injecting the electrolyte between the positive electrode and the negative electrode with a polypropylene separator having a thickness of about 16 μm disposed between the positive and negative electrodes.

### Example 8

A lithium secondary battery was manufactured in the same manner as in Example 7, except that 1.5 wt % of VC was not added.

### Comparative Example 1

A lithium secondary battery was manufactured in the same manner as in Example 1, except that 1 wt % of diethyl difluorosilane was not added.

### Comparative Example 2

A lithium secondary battery was manufactured in the same manner as in Example 1, except that 1 wt % of Compound A was added instead of 1 wt % of diethyl difluorosilane:

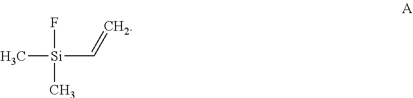

### Comparative Example 3

A lithium secondary battery was manufactured in the same manner as in Example 1, except that 1 wt % of Compound B was added instead of 1 wt % of diethyl difluorosilane:

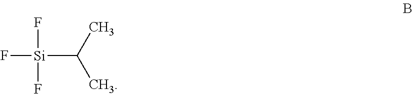

### Comparative Example 4

A lithium secondary battery was manufactured in the same manner as in Example 5, except that LiNi_{0.6}Co_{0.2}Mn_{0.2}O₂ was used as the positive active material instead of LiNi_{0.8}Co_{0.15}Mn_{0.05}O₂.

### Evaluation Example: Evaluation of Capacity Retention Rate, Recovery Retention Rate, and Gas Reducing Characteristics

The lithium secondary batteries prepared in Examples 1 to 8 and Comparative Examples 1 to 4 were subject to 200 charge/discharge cycles at a temperature of 25° C., under a charge/discharge current of 1 C/1 C, an operating voltage in a range of about 2.8 volts (V) to about 4.3 V, and a cut-off current of 1/10 C in a CC-CV mode. Then, capacity retention, recovery retention, and lifespan of the lithium secondary batteries were measured, and the results thereof are shown in Table 1. The capacity retention was determined by calculating a percentage of a capacity after 200th charge/discharge cycles relative to a capacity after the 1^{st} charge/discharge cycle under the same conditions. The recovery retention was determined by calculating a percentage of a recovery capacity after 200^{th} charge/discharge cycles relative to the recovery capacity at the time of the 1^{st} charge/discharge cycle under the same conditions. The gas reduction was determined by comparing the gas generation amount relative to Comparative Example 1.

TABLE 1

| | Capacity retention | Recovery retention | |
|---|---|---|---|
| | (%) | (%) | Gas reduction |
| Example 1 | 83.3 | 81.6 | 8% reduction |
| Example 2 | 81.8 | 81.5 | 16% reduction |
| Example 3 | 82.3 | 81.9 | 18% reduction |
| Example 4 | 82.1 | 81.3 | 13% reduction |
| Example 5 | 94.0 | 91.6 | 11% reduction |
| Example 6 | 94.6 | 94.6 | 16% reduction |
| Example 7 | 83.1 | 83.5 | 12% reduction |
| Example 8 | 81.7 | 81.0 | 18% reduction |
| Comparative | 82.9 | 82.4 | 12% increase |
| Example 1 | | | |
| Comparative | 77.8 | 77.5 | 21% reduction |
| Example 2 | | | |
| Comparative | 78.5 | 78.4 | 6% reduction |
| Example 3 | | | |
| Comparative | 91.4 | 89.6 | 19% increase |
| Example 4 | | | |

Referring to Table 1, the lithium secondary batteries of Examples 1 to 8, containing the electrolyte including a difluorosilane-based compound, were found to have improved capacity retention and improved gas generation characteristics, compared to the lithium secondary battery of Comparative Example 1 not including a disulfonate-based compound. For example, the lithium secondary batteries of Examples 1 to 7 using a difluorosilane-based compound along with VC was found to have further improved capacity retention and improved gas generation characteristics.

The lithium secondary battery of Comparative Example 4 using the positive electrode including a lesser amount of Ni, relative to the lithium secondary batteries of Examples 1 to 7, was found to have a reduced lifetime.

In addition, it was confirmed that, as compared with the lithium secondary batteries Examples 1 to 7, the lithium secondary battery of Comparative Example 3 including only one fluorine atom, rather than two fluorine atoms, showed improved gas generation characteristics. Without wishing to be bound by any theory, it is understood that due to a low capacity retention, the lithium secondary battery of Comparative Example 3 showed significant degradation in lifespan. Unlike the compounds described in the present disclosure, it may have been difficult for Compound A including only one fluorine atom to assist in reducing gas generation.

In addition, it was confirmed that, as compared with the lithium secondary batteries Examples 1 to 7, the lithium secondary battery of Comparative Example 4 including three fluorine atoms, rather than two fluorine atoms, showed a small effect in reducing gas generation. Without wishing to be bound by any theory, it is understood that due to a low capacity retention, the lithium secondary battery of Comparative Example 4 showed significant degradation in lifespan. In the case of Compound B including three fluorine atoms, since the number of the fluorine atom is relatively large, Compound B may have been unstable, making it difficult to bind to Ni cations, and the thermal stability of Compound B may also have been poor.

In some embodiments, lifespan and gas reduction characteristics of the lithium secondary battery may be improved by increasing a nickel content in the positive active material to maximize a battery capacity while maintaining the difluorosilane-based compound in a certain amount in the electrolyte.

It should be understood that embodiments described herein should be considered in a descriptive sense only and not for purposes of limitation. Descriptions of features or aspects within each embodiment should be considered as available for other similar features, advantages, or aspects in other embodiments.

While one or more embodiments have been described with reference to the FIGURES, it will be understood by those of ordinary skill in the art that various changes in form and details may be made therein without departing from the spirit and scope as defined by the following claims.

What is claimed is:

1. A lithium secondary battery comprising:
a positive electrode;
a negative electrode; and
an electrolyte between the positive electrode and the negative electrode, wherein
the positive electrode comprises a positive active material represented by Formula 1,
the electrolyte comprises a lithium salt, a non-aqueous solvent, and a difluorosilane compound represented by Formula 2, and
an amount of the difluorosilane compound is about 5 weight percent or less, based on a total weight of the electrolyte
LiₓNi_{y}M_{1-y}O_{2-z}A_{z} Formula 1 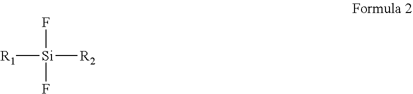
wherein, in Formula 1,
0.9≤x≤1.2, 0.7≤y≤0.98, and 0≤z<0.2,
M is Al, Mg, Mn, Co, Fe, Cr, V, Ti, Cu, B, Ca, Zn, Zr, Nb, Mo, Sr, Sb, W, and Bi, or a combination thereof,
A is an element having an oxidation number of −1, −2, or −3, and
in Formula 2, R₁ to R₂ are each independently a substituted or unsubstituted linear or branched C₁-C₃₀ alkyl group, a substituted or unsubstituted C₂-C₂₀ vinyl group, a substituted or unsubstituted C₂-C₂₀ allyl group, or a substituted or unsubstituted C₆-C₆₀ aryl group.

2. The lithium secondary battery of claim 1, wherein an amount of the difluorosilane compound is in a range of about 0.1 weight percent to about 5 weight percent, based on a total weight of the electrolyte.

3. The lithium secondary battery of claim 1, wherein the difluorosilane compound comprises diethyl difluorosilane, dipropyl difluorosilane, ethyl phenyl difluorosilane, diphenyl difluorosilane, or a combination thereof.

4. The lithium secondary battery of claim 1, wherein the lithium salt comprises lithium difluoro(oxalato)borate, LiBF₄, LiPF₆, LiCF₃SO₃, LiN(CF₃SO₂)₂, LiN(FSO₂)₂, or a combination thereof.

5. The lithium secondary battery of claim 1, wherein the non-aqueous solvent comprises dimethyl carbonate, diethyl carbonate, ethyl methyl carbonate, dipropyl carbonate, methyl propyl carbonate, ethyl propyl carbonate, ethylene carbonate, propylene carbonate, butylene carbonate, tetraethylene glycol dimethyl ether, or a combination thereof.

6. The lithium secondary battery of claim 1, wherein the non-aqueous solvent further comprises fluoroethylene carbonate.

7. The lithium secondary battery of claim 6, wherein an amount of fluoroethylene carbonate is in a range of about 0.1 volume percent to about 10 volume percent, based on a total volume of the non-aqueous solvent.

8. The lithium secondary battery of claim 1, wherein the electrolyte comprises a cyclic carbonate comprising a carbon-carbon double bond, a cyclic carboxylic anhydride comprising a carbon-carbon double bond, or a combination thereof.

9. The lithium secondary battery of claim 1, wherein the electrolyte further comprises vinylene carbonate, vinyl ethylene carbonate, a maleic anhydride, a succinic anhydride, or a combination thereof.

10. The lithium secondary battery of claim 1, wherein the electrolyte further comprises vinylene carbonate.

11. The lithium secondary battery of claim 9, wherein the vinylene carbonate, the maleic anhydride, or the combination thereof is present in an amount of about 0.1 weight percent to about 2 weight percent, based on a total weight of the electrolyte.

12. The lithium secondary battery of claim 1, wherein, in Formula 1, 0.8≤y≤0.98.

13. The lithium secondary battery of claim 1, wherein the positive active material is represented by Formula 3 or 4:
LiₓNi_{y′}Co_{1-y′-z′}Al_{z′}O₂, or Formula 3
Li_{x″}Ni_{y″}Co_{1-y″-z″}Mn_{z″}O₂ Formula 4
wherein, in Formula 3, 0.9≤x′≤1.2, 0.8≤y′≤0.98, 0<z′<0.1, and 0<1-y′-z′<0.2, and in Formula 4, 0.9≤x″≤1.2, 0.8≤y″≤0.98, 0<z″<0.1, and 0<1-y″-z″<0.2.

14. The lithium secondary battery of claim 1, wherein the positive electrode comprises Li_{1.02}Ni_{0.80}Co_{0.15}Mn_{0.05}O₂, Li_{1.02}Ni_{0.85}Co_{0.1}Mn_{0.05}O₂, Li_{1.02}Ni_{0.85}Co_{0.08}Mn_{0.04}O₂, Li_{1.02}Ni_{0.80}Co_{0.15}Al_{0.05}O₂, Li_{1.02}Ni_{0.85}Co_{0.1}Al_{0.05}O₂, Li_{1.02}Ni_{0.88}Co_{0.08}Al_{0.04}O₂, LiNi_{0.80}Co_{0.15}Mn_{0.05}O₂, LiNi_{0.85}Co_{0.1}Mn_{0.05}O₂, LiNi_{0.88}Co_{0.08}Mn_{0.04}O₂, LiNi_{0.80}Co_{0.15}Al_{0.05}O₂, LiNi_{0.85}Co_{0.1}Al_{0.05}O₂, LiNi_{0.88}Co_{0.08}Al_{0.04}O₂, or a combination thereof.

15. The lithium secondary battery of claim 1, wherein the negative electrode comprises a negative active material comprising a metal or metalloid that is alloyable with lithium, a carbonaceous negative active material, or a combination thereof.

16. The lithium secondary battery of claim 15, wherein the negative active material comprising a metalloid that is alloyable with lithium comprises silicon, a silicon-carbon composite material, SiO_{a′}, wherein 0<a′<2, or a combination thereof.

17. The lithium secondary battery of claim 16, wherein the negative active material comprises a silicon-carbon composite material comprising Si particles having an average particle diameter of about 200 nanometers or less.

18. The lithium secondary battery of claim 15, wherein the carbonaceous negative active material comprises graphite.

19. The lithium secondary battery of claim 1, wherein the lithium secondary battery has a capacity retention of about 80% or greater after a 200th charge/discharge cycle at a temperature of about 25° C.

20. The lithium secondary battery of claim 1, wherein the lithium secondary battery has a cell energy density of about 500 watt-hours per liter or greater.
